(19) United States
(12) Patent Application Publication
(10) Pub. No.: US 2007/0261526 A1
(43) Pub. Date: Nov. 15, 2007

(54) Bagel Slicer

(76) Inventor: Christopher H. Cunningham, Woodridge, IL (US)

Correspondence Address: PATENT GROUP;C/O DLA PIPER US LLP, 203 N. LASALLE ST., SUITE 1900, CHICAGO, IL, 60601, US

(21) Appl. No.: 11/635,778

(22) Filed: Dec. 6, 2006

Related U.S. Application Data
(60) Provisional application No. 60/748,287, filed on Dec. 6, 2005.

(51) Int. Cl. B26D 7/02

(52) U.S. Cl. 83/454

(57) ABSTRACT

A bagel slicer includes a generally U-shaped body featuring a pair of leg portions joined by a bridge portion. The bridge portion features an interior surface and each of the leg portions features an interior surface and a distal end. A pair of projections are positioned one each on the interior surfaces of the pair of leg portions near the distal ends. A cutting knife is mounted on, and is generally perpendicular to, the interior surface of the bridge portion so that the food item may be positioned between the leg portions and rotated about the projections so that the food item is sliced.

### CLAIM OF PRIORITY

This application claims priority from U.S. Provisional Patent Application Ser. No. 60/748,287, filed Dec. 6, 2005.

### BACKGROUND

The present invention relates generally to kitchen utensils and, more particularly, to a hand-held slicer for slicing food items such as bagels and the like.

### BRIEF DESCRIPTION OF THE DRAWINGS

FIG. 1 is a perspective view of an embodiment of the bagel slicer of the present invention;

FIG. 2 is a side elevational view of the bagel slicer of FIG. 1;

FIG. 3 is a bottom plan view of the bagel slicer of FIG. 1; and

FIG. 4 is a front elevational view of the bagel slicer of FIG. 1.

### DESCRIPTION OF EMBODIMENTS

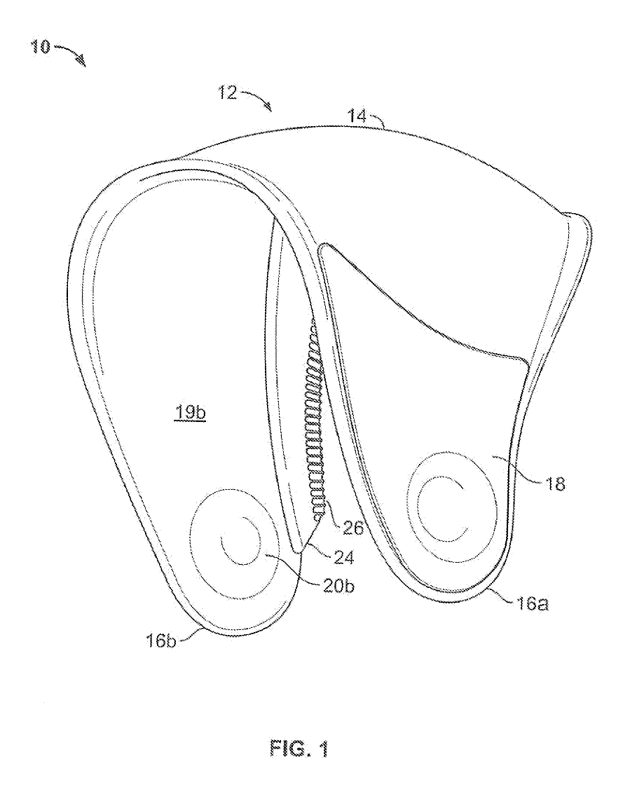

An embodiment of the bagel slicer of the present invention is indicated in general at 10 in FIGS. 1-4. While the term bagel slicer is used, it is to be understood that the device of the present invention could be used to slice other food items having a similar shape, such as donuts, English muffins and the like.

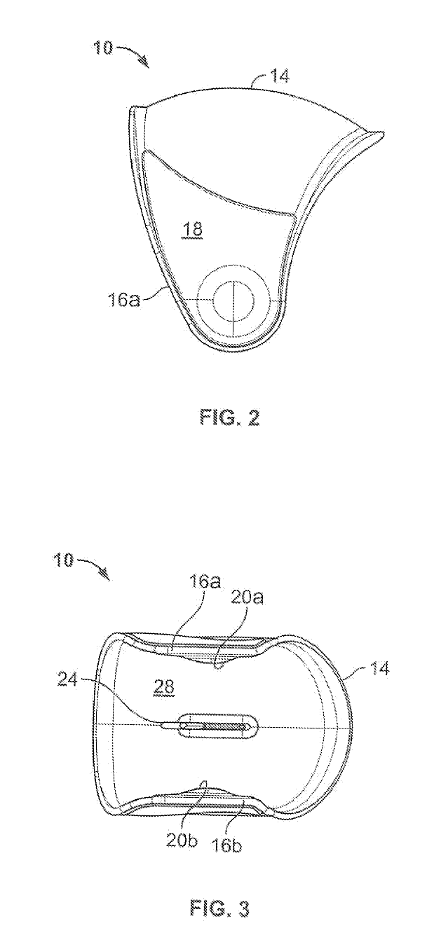

As illustrated in FIG. 1, the bagel slicer 10 features a generally U-shaped body, indicated in general at 12, that includes a bridge portion 14 and a pair of leg portions 16a and 16b. The body preferably is constructed of a slightly flexible material such as plastic. As indicated at 18 in FIGS. 1 and 2, each leg portion preferably is at least partially coated on its exterior surface near the distal end with a layer of a non-slip material such as SANTOPRENE.

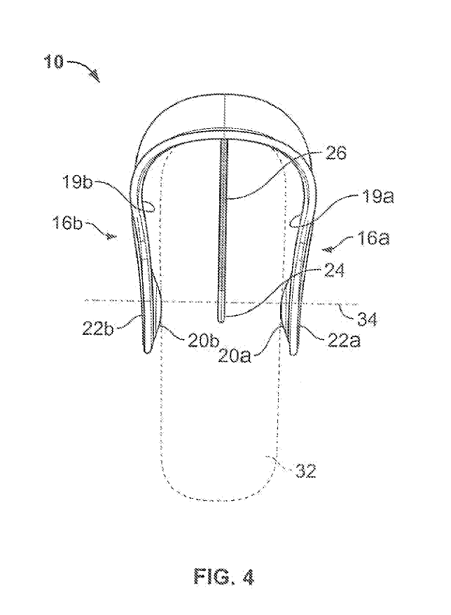

As illustrated in FIGS. 1, 3, and 4, the interior surfaces 19a and 19b (FIGS. 1 and 4) of each leg portion 16a and 16b are provided with dome-shaped projections 20a and 20b near their distal ends, indicated at 22a and 22b in FIG. 4. Alternative shapes may be used for the projections 20a and 20b, as long as they feature a generally circular cross section (such as with a cone or cylinder). Furthermore, as illustrated in FIGS. 1, 3 and 4 a cutting blade 24, preferably featuring serrations 26, is mounted near the center of the interior surface 28 (FIG. 3) of the bridge portion so as to be generally perpendicular to the interior surface.

In use, with reference to FIG. 4, the blade 24 is inserted into the side of a bagel, illustrated in phantom at 32, as it is positioned between the legs 16a and 16b. As best illustrated in FIGS. 3 and 4, the distal ends 22a and 22b of the legs are tapered towards one another so that the dome-shaped projections 20a and 20b engage the central hole of a bagel or the like. The leg portions are then grasped near their distal ends on the non slip material 18 by the thumb and fingers of a user's hand, with the exterior surface of the bridge portion facing the palm of the hand, and the bagel is rotated by the user's other hand about an axis 34 (FIG. 4) so that the blade slices the bagel generally in half.

As best illustrated in FIG. 2, the bridge portion 14 of the body features and arc-shaped contour to accommodate a bagel or similarly shaped food item and to facilitate gripping by user's hand.

Cutting blade 24 is preferably constructed of plastic and may be integrally molded with the body of the bagel slicer. Alternatively, the blade may be manufactured separately from the body and later joined or molded into the body. As a result, a metal blade alternatively may be used in the construction of the bagel slicer instead of a plastic one. While serrations are shown on the blade, they may be omitted or alternative serration or tooth arrangements may be utilized. The leg portions 16a and 16b of the bagel slicer also act as a guard to protect users from the blade.

While embodiments of the invention have been shown and described, it will be apparent to those skilled in the art that changes and modifications may be made therein without departing from the spirit of the invention.

What is claimed is:

1. A slicer for slicing a food item comprising:
a) a generally U-shaped body featuring a pair of leg portions joined by a bridge portion, said bridge portion featuring an interior surface and each of said leg portions featuring an interior surface and a distal end;
b) a pair of projections positioned one each on the interior surfaces of the pair of leg portions near the distal ends of the leg portions;
c) a cutting knife mounted on and generally perpendicular to the interior surface of the bridge portion so that the food item may be positioned between the leg portions and rotated about the projections so that the food item is sliced.

2. The slicer of claim 1 wherein the food item is a bagel.

3. The slicer of claim 1 wherein the body is constructed of plastic.

4. The slicer of claim 3 wherein the blade is constructed of plastic.

5. The slicer of claim 4 wherein the body and blade are integrally molded.

6. The slicer of claim 1 wherein the blade is serrated.

7. The slicer of claim 1 wherein each leg portion features an exterior surface that is provided with a layer of non-slip material near the distal end.

8. The slicer of claim 7 wherein the non-slip material is SANTOPRENE.

9. The slicer of claim 1 wherein the cutting blade is made of metal.

10. The slicer of claim 1 wherein the projections are dome-shaped.
